(19) United States
(12) Patent Application Publication
(10) Pub. No.: US 2010/0021515 A1
(43) Pub. Date: Jan. 28, 2010

(54) NOVEL COMPOSITIONS OF FUNGAL INOCULA, METHOD FOR THE PREPARATION THEREOF, AND USE THEREOF FOR IMPROVING THE GROWTH OF CULTURES

(75) Inventor: Robin Duponnois, Mercurey (FR)

Correspondence Address: YOUNG & THOMPSON, 209 Madison Street, Suite 500, Alexandria, VA, 22314, US

(73) Assignee: Institut De Recherche Pour Le Developpement (I.R.D, Paris Cedex 10 (FR)

(21) Appl. No.: 12/374,870

(22) PCT Filed: May 16, 2007
(86) PCT No.: PCT/FR2007/000828

§ 371 Date: May 14, 2009

(30) Foreign Application Priority Data
Jul. 25, 2006 (FR) 0606794

(51) Int. Cl. A01N 25/08; A01G 1/00; A01G 29/00

(52) U.S. Cl. 424/409; 47/58.1 SC

(57) ABSTRACT

This invention relates to novel compositions of fungal inocula, method for the preparation thereof, and use thereof for improving the growth of cultures.

This invention relates to novel compositions of fungal inocula, method for the preparation thereof, and use thereof for improving the growth of cultures

Mycorrhiza is a mutually beneficial association between a plant and a mycorrhizal fungus.

The importance of mycorrhizal fungi in tree plantations was shown for the first time in 1910 in endeavours for introducing exotic pine trees in Kenya. Whereas these plantations would generally result in spectacular failures (chlorotic plants, very high mortality), after advice from the “Royal Botanic Gardens”, an amount of soil from old pine plantations was imported from South Africa for use as a nursery cultivation substrate.

Indeed the soil contained mycorrhizae, which are mixed organs, situated on plant roots, and formed by juxtaposition of two types of organisms: the aerial plant, and the underground mycelial filaments of the fungus. The fungi will extract from the soil the mineral elements, and more particularly the lesser mobile ones such as zinc, copper and phosphorus, which they will deliver to the plant, and which are essential to its development. In exchange for this the plant delivers sugars and growth substances to the fungus, thus ensuring that it may survive. The mycorrhizae play an important part in the assimilation of some forms of nitrogen, and as well as in the absorption of ground water.

This technique, which uses a soil rich in mycorrhizal fungus propagulae, was rapidly successfully disclosed in other African countries such as Tanzania, Uganda, Malawi, etc.

Since then, several mycorrhiza techniques have been developed, and that which used mycorrhizal fungi only is now based upon the following steps: (i) Isolation and purification of fungal strains, (ii) selection of strains under controlled conditions of high performance fungal strains for a given parameter (for instance: effect of the strain on the growth of the host plant) and (iii) multiplication of the strain under axenic conditions and production of fungal inocula.

One may distinguish between two types of mycorrhizal fungi: ectomycorrhizal fungi, essentially pertaining to tree species, and endomycorrhizal fungi, which pertain to herbaceous vegetable species.

As to ectomycorrhizal fungi, two formulations of inoculum have been tested, and have shown spectacular effects in garden nurseries: (i) the peat-vermiculite type inoculum and (ii) the calcium alginate bead type inoculum.

Another technique using mycorrhizal bacteria has also been developed, notably in U.S. Pat. No. 5,935,839. This patent describes inoculum compositions which comprise mycorrhizal bacterial strains (Arthrobacter sp, Pseudomonas fluorescent) in order to foster coniferous tree growth.

A third technique using a mycorrhizal fungus association is also known. Thus French patent FR 2 678 281 describes the use of a peat-vermiculite type fungal inoculum comprising an ectomycorrhizal fungus (L. lacacata 10% (v:v)) in association with a bacterium (Bacillus, Pseudomonas fluorescent).

U.S. Pat. No. 6,133,196 describes the use of a peat-vermiculite-perlite type fungal inoculum comprising an ectomycorrhizal fungus (Heleboma arenosa or Laccaria bicolor) in association with a bacterium (Streptomyces, Pseudomonas diminuta).

One last technique comprising the association of a mycorrhizal fungus with other components has also been described and is for instance the subject of French Patent FR 2 865 897 relating to the production of fungal inocula comprising an endomycorrhizal fungus in association with a stimulating agent (sorgolactone, demethylsorgolactone, alectrole, strigole and orbanchole). The EP 0 209 627 patent relates to a process for the preparation of endomycorrhizal fungi in association with root organ cultures on a porous support made up of vermiculite alone or in association with peat.

Finally a publication by Duponnois R. et al. (FEMS Microbiology Ecology, 2006, 56:292-303) describes the use of an ectomycorrhizal fungus in association with termite nest powder for improving the growth of tree plants. The described composition includes an ectomycorrhizal fungus. This composition is used at the high dose of 1,000 ml per grain or plant.

However all these techniques have several disadvantages, the main one being the production in large amount of the inoculum, which necessitates comparatively sophisticated equipments, with costs, for instance for forestation operations, which are incompatible with the budgets as generally allocated for this kind of operation, and particularly in Southern countries.

Moreover the peat-vermiculite or alginate bead type fungal inoculum is generally produced in glass vials or plastic bags, which are rather bulky and which must be transported while respecting the cold chain.

One aim of the invention is to yield a fungal inoculum composition which may be used as an agent stimulating the mycorrhiza in cultures and having a formulation which is such that it may be used at doses which are clearly below those which are conventionally used.

Another aim of the invention is to yield fungal inoculum compositions which may be adapted to both types of mycorrhizal symbiosis (whether ectomycorrhizal or endomycorrhizal), allowing the production of mycorrhized plants in a wide spectrum of vegetable species, from fruit trees to forest tree plants, contrary to the state of the art, where the various common techniques may only be used for one type of mycorrhiza.

Another one of the aims of the invention is to yield fungal inoculum compositions wherein the association of two ectomycorrhizal and endomycorrhizal fungi allows one to stimulate the growth of rapid growth ligneous species belonging to the genera Casuarina, Allocasuarina, Eucalyptus and Australian Acacia.

Another aim of the invention is to yield a method for the stimulation of mycorrhiza which is such that it allows one to avoid fungal propagule losses as usually observed in conventional mycorrhiza techniques.

The invention relates to the use of at least one fungal and termite nest powder inoculum as an agent for the stimulation of culture mycorrhiza, notably for forest, cereal, fodder, garden, fruit or horticultural crops, said inoculum being used at a dose, for each cultivation unit element, notably for each grain or plant, which is about at least ten times below the dose which is used in the absence of any termite nest powder.

In the invention it has been found that the association of termite nest powder with a fungal inoculum allows one to sharply reduce the doses of inoculum which are used for mycorrhiza, and to thus foster reforestation, notably in the tropical and Mediterranean regions where the practice of controlled mycorrhiza is fully justified (deficient and eroded soils, severe desertification, threat on the conservation of biodiversity through anthropogene activities . . . ), by considerably diminishing its cost.

Given the dose which is used, a first advantage of the invention is to foster reforestation, notably in tropical and Mediterranean regions where the practice of controlled mycorrhiza is fully justified (deficient and eroded soils, severe desertification, threat on the conservation of biodiversity through anthropogene activities . . . ), by considerably diminishing its cost. Moreover the low amount of termite nest powder which is used (1-10% v:v) in the invention avoids any depopulation hazard in termite nests for whole areas.

The term <<cultivation unit element>> here means a grain, seed, fruit, pip, stone or plant, this list being non limitative, allowing one to obtain a forest, cereal, fodder, garden, fruit or horticultural crop.

The dose which is commonly used in the state of the art is between 100 ml-1,000 ml peat-vermiculite or calcium alginate type inoculum in association, or not, with another component for each grain. Therefore the dose which is used here is at least below 10 ml inoculum and termite nest powder per grain.

In a preferred embodiment of the invention the termite nest powder which is used is obtained from termites belonging to the genus Macrotermes and preferentially to the genus Macrotermes subhyalinus.

According to an advantageous embodiment of the invention the fungal inoculum comprises at least one endomycorrhizal fungus belonging to the genus Glomus, notably chosen from among Glomus mosseae, Glomus fasciculatus, Glomus aggregatum, Glomus intraradices and preferentially Glomus intraradices.

An endomycorrhizal fungus is a fungus whose mycelium penetrates into root cells and develops arbuscules or blisters when associated with plant roots. It forms no fungal mantle around the root. (Smith, S. E. & Read, D. J. (1997). Mycorrhizal symbiosis. 2^{nd} edition, UK, Academic Press.)

According to another advantageous embodiment of the invention the fungal inoculum comprises at least one ectomycorrhizal fungus, belonging to the genus Pisolithus, notably chosen from among Pisolithus albus, Pisolithus tinctorius, or to the genus Scleroderma, notably chosen from among Scleroderma dyctiosporum, Scleroderma verrucosum and preferentially Scleroderma dictyosporum,

An ectomycorrhizal fungus is a fungus whose mycehium develops between root cortex cells, but does not penetrate into living cells, thus forming <<Hartig's intercellular network>>. It forms a fungal mantle around the root. (Smith, S. & Read, D. J. (1997). Mycorrhizal symbiosis. 2^{nd} edition, UK, Academic Press.)

According to another advantageous embodiment of the invention the fungal inoculum comprises an endomycorrhizal fungus belonging to the genus Glomus, notably chosen from among Glomus mosseae, Glomus fasciculatus, Glomus aggregatum, Glomus intraradices and preferentially Glomus intraradices, and an ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum and preferentially Scleroderma dictyosporum.

This association between an ectomycorrhizal fungus and an endomycorrhizal fungus is more particularly advantageous for rapid growth ligneous species belonging to the genera Casuarina, Allocasuarina, Eucalyptus and Australian Acacia.

These tree species are frequently used in reforestation programmes in humid and dry tropical environments, and the association of the two types of mycorrhizal fungi allows one to obtain gains in growth in relation to that which is observed when only one type of fungus is inoculated. (see FIG. 1)

According to a preferred embodiment of the invention the fungal inoculum is prepared by growing on a support an endomycorrhizal fungus or an ectomycorrhizal fungus, the endomycorrhizal fungus growth taking place on a support or carrier medium, notably sandy type, and notably in the presence of a mycotrophic plant, the growth of the ectomycorrhizal fungus taking place on a peat-vermiculite or calcium alginate bead type support.

As to the endomycorrhizal fungus, this may be seen for instance in the form of mycorrhized dry roots, which are cut into 1 mm pieces (comprising ca. 25 blisters per mm roots) and mixed with sand (sterilized at 140° C. during 40 min) at a dose of 2 g mycorrhized roots of said endomycorrhizal fungus.

Thanks to the development of its roots a mycotrophic plant multiplies the endomycorrhizal fungus.

As examples of mycotrophic plants one may cite millet, sorghum and maize.

The necessary time for growth with the help of the mycotrophic plant is about 4 months.

As to the ectomycorrhizal fungus the support which is used is of the peat-vermiculite type, and the fungal strain (a fungal implant which is taken from a <<parent>> culture, at a dose of about 10 mg biomass—dry weight—per implant) develops and colonizes under sterile conditions a mixture of peat and vermiculite (1:4; v:v) which is humidified with a nutrient solution.

According to an advantageous embodiment, after cultivation for three months in vials at 25° C. the fungal inoculum is mixed with the culture substrate at a rate of 1 volume inoculum for 9 volumes culture soil.

This mixture is then distributed into sheaths, wherein the chosen tree species is planted. If production is carried out in nursery flats, the inoculum may be brought at a rate of 2 for each square metre of the soil wherein grains of the chosen species will be sown.

In the case of the alginate bead support, according to an advantageous embodiment, the mycelium is multiplied in a liquid nutritive medium in a fermenter, then ground and mixed with a sodium alginate solution. This mycelium fragment suspension is then poured, in a dropwise fashion, onto a calcium chloride solution. The alginate polymerizes in the presence of calcium, thus yielding calcium alginate beads having a chosen diameter containing fungal propagules. These beads are then inoculated into the soil of nursery flats at a rate of 1 litre inoculum per sq. m.

According to another advantageous embodiment of the invention the fungal inoculum and the termite nest powder are associated with a substrate, notably chosen from among sand, compost from culture residues and preferentially garden mould, or a mixture of sand and compost

The fungal inoculum which is used here at the time of use is the fungal inoculum after growth, for instance during 4 months for the endomycorrhizal fungus, and three months, for instance, in vials for the ectomycorrhizal fungus.

The term compost here means a product which is obtained by controlled conversion and recovering of organic matters (biomass by-products, organic refuse of biological origin) into a stabilized and hygienic product which is rich in humic compounds.

According to a preferred embodiment of the invention, the fungal inoculum:termite nest powder ratio is between 0.1% (v:v)-10% (v:v), preferentially between 0.1% (v:v)-5% (v:v) and more preferentially between 0.1% (v:v)-1% (v:v)

The low amount of termite nest powder which is used (0.1%-10% v:v) in the invention avoids any depopulation hazard, in entire areas, for termite nests.

According to another advantageous embodiment of the invention, the fungal inoculum:substrate ratio of the inoculum is between 1% (v:v)-10% (v:v), preferentially between 1% (v:v)-5% (v:v), and more preferentially 1% (v:v).

According to yet another advantageous embodiment of the invention, the termite nest powder:inoculum substrate ratio is between 1% (v:v)-10% (v:v), preferentially 1% (v:v)-5% (v:v), and more preferentially 1% (v:v).

According to still another embodiment of the above-described process, the endomycorrhizal fungus is used in areas to be cultivated, notably for cereal, fodder, garden, fruit or horticultural crops, and preferentially garden, fruit or horticultural crops.

Cereal crops notably include barley, oats and wheat, this list being non limitative.

Fodder crops include leguminosae such as clover, alfalfa and birds' foot trefoil, and gramineae such as common timothy and cock's foot, this list being non limitative.

Garden crops notably include tomatoes, eggplants, potatoes, carrots, lettuce, cucumber, melon, cabbage, cauliflower . . . .

Fruit crops notably include apples, pears, peaches, grapes, cherries, plums, citrus fruits, this list being non limitative.

Horticultural crops notably include flowers and ornamental plants, this list being non limitative.

The term <<areas to be cultivated>> here means any type of container including elements which are appropriate for cultivation, such as pots, flats, vials, seed trays, this list being non limitative, as well as any type of soil, ground plot, field, greenhouse, & c.

In a preferred embodiment of the above-described process the ectomycorrhizal fungus is used in areas to be used in forestry.

The term areas to be cultivated has here the same meaning as above.

Forestry includes the raising of myrtaceae, pinaceae, abietaceac, fagaceae, tiliaceae, ulmaceae, salicaceae; this list being non limitative.

According to another advantageous embodiment of the invention, an endomycorrhizal fungus and an ectomycorrhizal fungus are used in areas to be used in forestry, notably for ligneous species belonging to the genera Casuarina, Allocasuarina, Eucalyptus and Australian Acacia.

Both fungi are used in the same manner as hereabove described for each fungus, viz. the endomycorrhizal fungus is mixed with a support, notably sandy type, and the ectomycorrhizal fungus is grown on a peat-vermiculite or calcium alginate bead support, for instance during three months.

The invention also relates to a composition comprising:
a. a fungal inoculum comprising at least an endomycorrhizal fungus belonging to the genus Glomus, notably chosen from among Glomus mosseae, Glomus fasciculatus, Glomus aggregatum, Glomus intraradices and preferentially Glomus intraradices,
b. termite nest powder, wherein the particle size of said termite nest powder is between 1 μm-1,000 μm and preferentially between 1 μm-500 μm,

This sieve allows one only to eliminate coarse particles from the structure of termite nests (such as stones).

These particles are again taken and ground. Generally over 95% (volume) of the termite nest may be ground and powdered.

If the powder is not ground, the particles are too coarse and the termite nest structures cannot be homogeneously distributed into the substrate,
the fungal inoculum:termite nest powder ratio being between 0.1% (v:v)-10% (v:v), preferentially between 0.1 (v:v)-5% (v:v), and more preferentially between 0.1 (v:v)-1% (v:v).

The above-described composition allows one to stimulate mycorrhiza, notably for cereal, fodder, garden, fruit or horticultural crops.

According to a preferred embodiment of the invention, the above-described fungal inoculum comprises:

i. at least an endomycorrhizal fungus

ii. a sandy type support

iii. a mycotrophic plant.

The fungal inoculum is obtained for instance from the growth of a dose of 2 g endomycorrhizal fungus mycorrhized roots.

This dose is also that which is used in the invention.

According to another embodiment of the invention said composition comprises:
a. a fungal inoculum with at least one endomycorrhizal fungus,
b. termite nest powder,
c. a substrate which is chosen from among composts as obtained from cultivation residues, and preferentially from garden mould, sand, or a mixture of sand and compost,
the termite nest powder:substrate ratio being between 1% (v:v)-10% (v:v) and preferentially between 1% (v:v)-5% (v:v), and more preferentially being 1%, (v:v) and the fungal inoculum:substrate ratio being between 1% (v:v)-10% (v:v), preferentially between 1% (v:v)-5% (v:v), and more preferentially being 1% (v:v).

The term compost as used here has the same meaning as hereabove.

The invention also relates to a composition comprising:
a. a fungal inoculum comprising at least an ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum and preferentially Scleroderma dictyosporum,
b. termite nest powder, the particle size of said powder being between 1 μm-1,000 μm, preferentially between 1 μm-500 μm,
c. a substrate chosen from among sand, compost from cultivation residues, and preferentially garden mould, or a mixture of sand and compost,
the fungal inoculum:termite nest powder ratio being between 0.1% (v:v)-10% (v:v), preferentially between 0.1% (v:v)-5% (v:v), and more preferentially between 0.1% (v:v)-1% (v:v), and
the fungal inoculum:substrate ratio being between 1% (v:v)-10% (v:v), preferentially between 1% (v:v)-5% (v:v), and more preferentially being 1% (v:v), and
the termite nest powder:substrate ratio being between 1% (v:v)-10% (v:v), preferentially between 1% (v:v)-5% (v:v), and more preferentially being 1% (v:v)
   it being understood that at least one of the two ratios, viz. fungal inoculum:substrate or termite nest powder:substrate, is below 10% (v:v), and preferentially that at least one of the two above-mentioned ratios is between 1% (v:v)-5% (v:v).

The above-described composition allows one to stimulate mycorrhiza for cultivation, notably for forest trees.

According to another embodiment of the invention, the fungal inoculum having the above-described composition comprises:

i. at least an ectomycorrhizal fungus

ii. a peat-vermiculite (1:4, v:v) or calcium alginate bead type support.

The fungal inoculum is obtained for instance from the growth of a 10 mg dose (dry weight) of ectomycorrhizal fungus biomass.

The invention also relates to a composition comprising:
a. a fungal inoculum comprising an endomycorrhizal fungus belonging to the genus Glomus, notably chosen from among Glomus mosseae, Glomus fasciculatus, Glomus aggregatum, Glomus intraradices and preferentially Glomus intraradices, and an ectomycorrhizal fungus belonging to the genus Pisolithus, notably chosen from among Pisolithus albus, Pisolithus tinctorius, or the genus Scleroderma, notably chosen from among Scleroderma dyctiosporum, Scleroderma verrucosum and preferentially Scleroderma dictyosporum,
b. termite nest powder, the particle size of said powder being between 1 μm-1,000 μm and preferentially between 1 μm-500 μm,
   the fungal inoculum:powder ratio being between 0.1% (v:v)-10% (v:v), preferentially between 0.1% (v:v)-5% (v:v), and more preferentially between 0.1 (v:v)-1% (v:v).

The above-described composition allows one to stimulate mycorrhiza for forest trees, notably for ligneous species belonging to the genera Casuarina, Allocasuarinia, Eucalyptus and Australian Acacia.

According to a preferred embodiment of the invention, the fungal inoculum having the above-mentioned composition comprises:
i. at least an endomycorrhizal fungus and an ectomycorrhizal fungus,
ii. a sandy type support in the presence of a mycotrophic plant for the endomycorrhizal fungus, and a peat-vermiculite (1:4, v:v) or calcium alginate type support for the ectomycorrhizal fungus.

The fungal inoculum is obtained for instance from the growth of a 2 g dose of mycorrhized endomycorrhizal fungus roots, and for instance from the growth of a 10 mg dose of ectomycorrhizal fungus biomass (dry weight).

According to a preferred embodiment of the invention, the composition comprises:
a. a fungal inoculum,
b. termite nest powder,
c. a substrate chosen from among compost as obtained from cultivation residues and preferentially garden mould, sand, or a mixture of sand and compost,
   the termite nest powder:substrate ratio being between 1% (v:v)-10% (v:v 3, preferentially between 1% (v:v)-5% (v:v), and more preferentially being 1% (v:v), and the fungal inoculum substrate ratio being between 1% (v:v)-10% (v:v), preferentially between 1% (v:v)-5% (v:v), and more preferentially 1% (v:v).

According to a preferred embodiment, in all hereabove-described compositions, the termite nest powder is obtained from termites belonging to the genus Macrotermes and preferentially to the genus Macrotermes subhyalinus.

The invention also relates to a process for the stimulation of mycorrhiza in areas to be cultivated, wherein a mixture of fungal inoculum and termite nest powder, which may be comminuted, has been introduced, the fungal inoculum having been prepared through the growth of at least one endomycorrhizal fungus with a support, or through the growth of at least one ectomycorrhizal fungus on a support, and said inoculum being used at a dose, for each cultivation unit element, notably for each grain or plant, which is at least ten times below the dose which is used in the absence of termite nest powder.

The term <<cultivation unit element>> here means a grain, seed, fruit, pip, stone or plant, this list being non limitative, allowing one to obtain a forest, cereal, fodder, garden, fruit or horticultural crop.

According to a preferred embodiment of the above-described process, the fungal inoculum dose par cultivation unit element being between 0.01-1 ml and preferentially between 0.01-0.1 ml.

According to another preferred embodiment of the invention, the inoculum as used in the above-described process is a fungal inoculum which is specific for endomycorrhiza, comprising at least one endomycorrhizal fungus belonging to the genus Glomus, notably chosen from among Glomus mosseae, Glomus fasciculatus, Glomus aggregatum, Glomus intraradices and preferentially Glomus intraradices.

According to yet another preferred embodiment of the invention, the inoculum as used in the above-described process is a fungal inoculum which is specific for ectomycorrhiza, comprising at least one ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum and preferentially Scleroderma dictyosporum.

In another embodiment the fungal inoculum is an inoculum which comprises at least one endomycorrhizal fungus belonging to the genus Glomus, notably chosen from among Glomus mosseae, Glomus fasciculatus, Glomus aggregatum, Glomus intraradices and preferentially Glomus intraradices, and at least one ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum, and preferentially Scleroderma dictyosporum.

According to a preferred embodiment of the above-described process, the particle size of said powder is between 1 μm 1,000 μm, and preferentially between 1 μm-500 μm.

According to another preferred embodiment the termite nest powder is obtained from termites belonging to the genus Macrotermes, and preferentially to the genus Macrotermes subhyalinus.

According to yet another embodiment of the above-described process, a mixture of a fungal inoculum and termite nest powder, which may be comminuted, has been introduced, wherein the fungal inoculum and the termite nest powder have been mixed with a substrate, and said fungal inoculum has been prepared by the growth of a mycorrhizal fungus on a support.

According to a preferred embodiment the inoculum:termite nest powder ratio is between 0.1% (v:v)-10% (v:v), preferentially between 0.1 (v:v)-5% (v:v), and more preferentially between 0.1% (v:v)-1% (v:v).

According to another preferred embodiment, the fungal inoculum is prepared by growing at least one endomycorrhizal fungus at a dose of about 2 g mycorrhized roots of said endomycorrhizal fungus on a support made up of sand in association with a mycotrophic plant, or by growing at least one ectomycorrhizal fungus at a dose of about 10 mg ectomycorrhizal fungus biomass (dry weight) on a support made up of peat/vermiculite (1:4, v:v) or calcium alginate beads.

According to yet another preferred embodiment, the fungal inoculum and the termite nest powder are mixed with a substrate, said substrate being chosen from among sand, compost as obtained from cultivation residues and preferentially from garden mould, or a mixture of sand and compost,

the fungal inoculum:substrate ratio being between 1% (v:v)-10% (v:v), preferentially between 1% (v:v)-5% (v:v), and being preferentially 1% (v:v) and the termite nest powder:substrate ratio being between 1% (v:v)-10% (v:v), preferentially between 1% (v:v))-5% (v:v), and being preferentially 1% (v:v)

According to a preferred embodiment, the process includes a step for the introduction of a cultivation unit element in areas to be cultivated, and which has been previously filled with the fungal inoculum and the termite nest powder, said cultivation unit element notably being a grain or a plant.

The grain or the plant are introduced into an area which already contains the fungal inoculum.

According to another embodiment, the process comprises the following steps:
a. preparation of the fungal inoculum by growing at least one endomycorrhizal fungus and growing at least one ectomycorrhizal fungus on a support,
b. mixing of the termite nest powder, which may be comminuted, and the fungal inoculum with a substrate,
c. introduction of the mixture as obtained at the preceding step into areas which are to be cultivated at a dose, for each cultivation unit element, of 0.01-1 ml fungal inoculum, and preferentially of 0.01-0.1 ml fungal inoculum,
d. introduction of a cultivation unit element, notably of a grain to be cultivated or of a plant, into areas to be cultivated and containing the mixture.

This process includes a pre-inoculation step of plants in a flat, in a reduced soil volume, the advantage being to avoid fungal propagule losses as usually observed with conventional mycorrhiza techniques.

### DESCRIPTION OF FIGURES

FIG. 1 represents the influence of the proportion of termite nest powder on the mycorrhizal colonization of A. holosericea sowings with the various mycorrhizal inoculation treatments

(A) Endomycorrhizal inoculation (first culture)
------ PIF 1%. y=18.53 Ln x+36.9. R=0.78. p<0.0001
-•-•- PIF 5%. y=15.99 Ln x+27.9. R=0.61. p=0.004 [symbol]
PIF 10%. y=15.45 Ln x+41.48. R=0.67. p=0.0012
(B) Endomycorrhizal inoculation (second culture)

------ PIF 1%. y=5.73 Ln x+34.7. R=0.48. p<0.031

-•-•- PIF 5%. y=1.69 Ln x+67.9. R=0.14. p=0.56

[symbol] PIF 10%. y=11.9 Ln x+40.9. R=0.67. p=0.005

PIF: Proportion of fungal inoculum

The 59.3% continuous line on graphs (A) and (B) represents the mycorrhizal colonization of A. holosericea sowings as obtained by a fungal inoculation as usually carried out in nurseries (Table 6).

(C) Ectomycorrhizal inoculation (first culture)

------ PIF 1%. y=10.98 Ln x+408. R=0.73. p<0.0003

-•-•- PIF 5%. y=4.26 Ln x+49.4. R=0.34. p=0.14

[symbol] PIF 10%. y=0.64 Ln x+49.6. R=0.67. p=0.81

(D) Ectomycorrhizal inoculation (first culture)

PIF 1%. y=2.87 Ln x+541. R=0.30. p=0.19

-•-•- PIF 5%. y=4.12 Ln x+56.1. R=0.58. p=0.007

[symbol] PIF 10%. y=6.3 Ln x+53.9. R=0.71. p=0.0004

PIF: P Proportion of fungal inoculum

The 35.6% continuous line on graphs (C) and (D) represents the mycorrhizal colonization of A. holosericea sowings as obtained by fungal inoculation as usually carried out in nurseries (Table 6).

FIG. 2 represents the effect of the termite nest powder improvement on the growth of A. holosericea sowings with various densities of fungal inoculum after 4 months cultivation in a greenhouse.

(A) Endomycorrhizal inoculation (first culture) [symbol]
PAT=0%. y=474.6 Ln x+464.7. R=0.87. p<0.0001 [symbol]
PAT=1%. y 785.1 Ln x+732.1. R=0.84. p<0.0001 [symbol]
PAT=5%. y=643.9 Ln x+810.5. R 0.76. p<0.0001 [symbol]
PAT=10%. y=745.6 Ln x+759. R=0.79. p<0.0001
(B) Endomycorrhizal inoculation (second culture) [symbol]
PAT=0%. y=522.6 Ln x+246.6. R=0.93. p<0.0001 [symbol]
PAT=1%. y=803.9 Ln x+293.6. R=0.84. p<0.0001 [symbol]
PAT=5%. y=684.1 Ln x+478.9. R=0.76. p<0.0001 [symbol]
PAT=10%. y=536.6 Ln x+594.5. R 0.79. p<0.0001

PAT: Proportion of termite nest powder improvement

The 2380.4 mg hatched line represents the total biomass of A. holosericea sowings as inoculated with G. intraradices (A,B) using the conventional controlled mycorrhiza method. (See Table 6).

(C) Ectomycorrhizal inoculation (first culture) [symbol]
PAT=0%. y=549.7 Ln x+225.9. R=0.73. p 0.0002 [symbol]
PAT=1%. y=174.2 Ln x+477.8. R=0.63. p 0.003 [symbol]
PAT=5%. y=−33.2 x²+412.7 x+378.6. R=0.60. p=0.02 [symbol]
PAT=10%.-14.9 x²+168.4 x+710. R=0.29. p=0.47
(D) Ectomycorrhizal inoculation (first culture) [symbol]
PAT=0%. y=398.7 Ln x+181.3. R=0.82. p<0.0001 [symbol]
PAT=1%. y 429.7 Ln x+282.4. R=0.90. p<0.0001 [symbol]
PAT=5%. y=490.7 Ln x+509.9. R=0.85. p<0.0001 [symbol]
PAT 10%. y=617.9 Ln x+178.1. R=0.79. p<0.0001

PAT: Proportion of termite nest powder improvement

The 1680.3 mg hatched line represents the total biomass of A. holosericea sowings as inoculated with P. albus IR100 (C, D) using the conventional controlled mycorrhiza method. (See Table 6).

### EXAMPLES

### Example 1

### Analysis of M. subhyalinus Termite Nests

M. subhyalinus termite nest samples were taken in a shrub savanna some 50 km North of Ouagadougou in Burkina Faso. They were ground, then sieved on a 2 mm sieve before use. The chemical and microbiological characteristics are presented in Table I:

TABLE I
Chemical and microbiological characteristics of
Macrotermes subhyalinus termite nest powder.

| | |
|---|---|
| NH₄⁺ (μg N g⁻¹ dry termite nest powder) | 9.4 |
| NO₃⁻ (μg N g⁻¹ dry termite nest powder) | 3408.9 |
| Available P (μg g⁻¹ dry termite nest powder) | 3.5 |
| Microbial biomass (μg C g⁻¹ dry termite nest powder) | 22.5 |
| Fluorescent Pseudomonas (×10² CFU g⁻¹ dry termite | 79.3 |
| nest powder) | |
| Actinomycetes (×10² CFU g⁻¹ dry termite nest powder) | 39.5 |
| Ergosterol (μg g⁻¹ dry termite nest powder) | 0.316 |

In brief, the NH₄⁺ and NO₃⁻ content was measured according to the Bremner method (Bremner J. M., Inorganic forms of nitrogen. Methods of Soil Analysis, Part 2. Agronomy Monographs, Vol. 9, (Black C A, ed.), pp. 1179-1237. Agronomy Society of America and Soil Science Society of America, Madison, Wis., (1965)), the available phosphorus was determined according to Olsen et al. (Olsen S R, Cole C V, Watanabe F S & Dean L A Estimation of available phosphorus in soils by extraction with sodium bicarbonate. Circular, Vol. 939, p. 19. US Department of Agriculture, Washington D.C. (1954)). The ergosterol content was determined using the Grand and West method (Grant W D &West A W Measurement of ergosterol, diaminopimelic acid and glucosamine in soil: evaluation as indicators of microbial biomass. J Microbiol 6: 47-53, (1986)). The extraction-fumigation method was used to assess the microbial biomass (Amato M & Ladd J M (1988) Assay for microbial biomass based on ninhydrin-reactive nitrogen in extracts of fumigated soils. Soil Biol Biochem 20: 107-114.). The numeration of Colony Forming Units (CFU) was carried out on King B agar medium for fluorescent Pseudomonas (King E O, Ward M K & Raney D E (1954) Two simple media for the demonstration of pyocyanine and fluorescein. J Lab Clin Med 44: 301-307) and on an agar medium without actinomycetes (Difco Laboratories, Detroit, Mi) for actinomycetes. Most fluorescent Pseudomonas belong to the species Pseudomonas monteillii (Duponnois, R., Assigbetse, K., Ramanankierana, Kisa, M., Thioulouse, J. & Lepage, M. (2006). Litter-forager termite mounds enhance the ectomycorrhizal symbiosis between Acacia holosericea A. Cunn. Ex G. Don and Scleroderma dictyosporum isolates. FEMS Microbiology Ecology, 56: 292-303).

### Example 2

### Preparation of the Fungal Inoculum

The ectomycorrhizal fungus P. albus IR100 was maintained on a Melin-Norkrans (MMN) agar medium at 25° C. (Marx, DH (1969) The influence of ectotropic mycorrhizal fungi on the resistance of pine roots to pathogenic infections: 1. Antagonism of mycorrhizal fungi to root pathogenic fungi and soil bacteria. Phytopathology 59: 153-163). The ectomycorrhizal fungal inoculum was prepared according to Duponnois and Garbaye (Duponnois R, Garbaye J (1991) Techniques for controlled synthesis of the Douglas fir-Laccaria laccata ectomycorrhizal symbiosis. Ann Sci For 48:239-251). One litre glass vials were filled with 600 ml of a mixture of vermiculite and peat (4:1; v:v) and autoclaved (120° C., 20 min). 300 ml MMN liquid were then added to the substrate, the vials were sealed and autoclaved at 120° C. during 20 min. After cooling the substrate was inoculated with fungal cones taken on the fringe of fungal colonies. The glass vials were placed at 25° C. in the dark during 3 months. An autoclaved humidified mixture of vermiculite and peat (MMN medium) was used for control without ectomycorrhizal inoculation.

The endomycorrhizal fungus G. intraradices (DAOM 181 602, Ottawa Agricultural Herbarium) was cultivated on millet (Penisetum typhoides cv. IKMV 8201) during 12 weeks in a greenhouse on an autoclaved sandy soil (120° C., 60′). The endomycorrhizal inoculum is made up of a mixture of rhizosphere soil containing spores, mycelium and mycorrhized roots, cut into 1-3 mm long chunks bearing ca. 250 blisters per sq. cm. Non mycorrhized millet roots, prepared as hereabove described, have been used for a control without endomycorrhizal inoculation.

### Example 3

### Experimental Design

A. holosericea seeds were sterilized on their surface with 95% sulfuric acid during 60 min. The acid solution was then allowed to settle and the seeds were rinsed, then dipped during 12 hours in sterile distilled water. The seeds were then aseptically transferred in Petri boxes filled with 1% (m/v) agar/water medium. These boxes were incubated at 25° C. in the dark. The germinated seeds were used when roots were 1-2 cm long.

The sandy soil which was used in this experiment was collected in a A. holoserica population east of Dakar. After harvest the soil was ground, passed through a 2 mm sieve and autoclaved during 60 min at 120° C. in order to eliminate the native microflora. After autoclaving, its physico-chemical characteristics were the following: pH (H₂O) 5.3; 3.6% clay; 0.0% fine silt; 0.8% coarse silt; 55.5% fine sand; 39.4% coarse sand; 0.17% carbon; 0.02% nitrogen; 8.5 C/N; 39 ppm total P and 4.8 ppm soluble P (Olsen S R, Cole C V, Watanabe F S & Dean L A (1954) Estimation of available phosphorus in soils by extraction with sodium bicarbonate. Circular, Vol. 939, p. 19. US Department of Agriculture, Washington D.C.). This soil was mixed with 0, 1, 5 and 10% (v/v) M. Suthyalinus termite nest powder. The ectomycorrhizal and endomycorrhizal inoculation was carried out by mixing the soils with a fungal inoculum (10/1; v/v), with an autoclaved vermiculite-peat mixture in the same ratio (ectomycorrhizal control), or with non mycorrhized millet roots and their rhizospheric soil (endomycorrhizal control).

Plastic containers (30×30×5 cm) filled with mixtures of these soils were each sown with 100 germinated A. holosericea seeds. The seedlings were kept in a greenhouse under natural light (ca. 12 h daylight, mean daily temperature 30° C.) and watered without fertilizers every third day. Three containers for each treatment were placed in a completely random manner.

After 1-2 months cultivation, five plants for each container were uprooted and transferred into a 1 litre pot (one seedling per pot), filled with the same sterilised soil but without termite nest powder improvement nor fungal inoculation. Seedlings were kept in a greenhouse under the same conditions as those hereabove described, and were watered daily without any fertilizer. The pots were placed in a completely random manner, with 15 pots for each treatment. After 3 (first transplanting) and 2 (second transplantings) months of culture, five A. holosericea plants chosen in a random manner for each treatment were uprooted, and the root systems were carefully washed. The seedling dry weight (one week at 65° C.) was measured. The root systems were cut to 1 cm pieces and mixed. The percentage of ectomycorrhizal short roots ([number of ectomycorrhizal short roots/total number of short roots]×100) was determined under a stereomicroscope at a magnification of 40× on a random sample of at least 50 short roots for each root system. The inner endomycorrhizal fungus colonization along the root systems was quantified by root clearing and staining following the method of Phillips and Hayman (Phillips, J. M., Hayman, D. S., 1970. Improved procedures for clearing roots and staining parasitic and vesicular-arbuscular mycorrhizal fungi for rapid assessment of infection. Trans. Br. Mycol. Soc. 55, 158-161). The root pieces were placed on a plate to be observed under a microscope at a magnification of 250. (Brundrett, M. C., Piche, Y., Peterson, R. L., 1985. A developmental study of the early stages in vesicular-arbuscular mycorrhizal formation. Can. J. Bot. 63, 184-194). The extent of mycorrhizal colonization was expressed in terms of root length fraction with mycorrhizal inner structures (blisters or mycelium):(length of colonized root fragment/total length of root fragments)×100, then the dry weight of the roots was measured (1 week at 65° C.).

In parallel with this experiment, A. holosericea seedlings were cultured in 1 litre pots filled with the same disinfected soil as herebefore. For the ectomycorrhizal inoculation, the soil was mixed with a P. albus IR 100 fungal inoculum (10/1; v/v). The control (without fungus) received an autoclaved vermiculite-humid peat mixture (MIN medium) in the same ratio. For the endomycorrhizal inoculation a hole (1 cm×5 cm) was made in each pot, and this was filled with one grain fresh millet root (mycorrhized or non mycorrhized for the control treatment without fungus). The holes were then covered with the same autoclaved soil. The plants were daily watered without a fertilizer, and placed in a completely random manner with eight samples for each treatment. They were kept in a greenhouse under natural light (ca. 12 h daylight, average daily temperature 30° C.). After 4 months cultivation the A. holosericea plants were uprooted, and their aerial and root biomasses, and their mycorrhizal indexes, were measured as hereabove described.

### Example 4

### Statistical Analysis

Data were treated using a variance analysis with one or two variables. Means were compared using the Newman and Keuls test (p<0.05). Mycorrhizal colonization percentages were transformed with arc sin (sqrt) before statistical analysis.

### Example 5

### Results

Effects of endomycorrhizal fungal inoculation and of termite nest powder improvement on plant growth and mycorrhizal colonization of A. holosericea seedlings.

For every proportion of combined fungal inoculum and for the two culture treatments, there are significant differences between the aerial and root biomasses and the mycorrhizal colonization of A. holosericea seedlings (Tables 2 and 3).

TABLE 2
Effect of various proportions of endomycorrhizal inoculation and of termite nest
powder improvements on the growth of A. holosericea and on the mycorrhizal development
after 3 months' cultivation in 1 litre pots (First plantation).

| | Aerial biomass | | Root biomass | Mycorrhizal |
|---|---|---|---|---|
| Factor ^{(A)} | (mg dry weight) | | (mg dry weight) | colonization (%) |
| Proportion of | | | | |
| fungal inoculum (%) | | | | |
| 0 | 278.5 | (26.8) ⁽¹⁾ a ⁽²⁾ | 62.5 (8.9) a | 0 a |
| 1 | 1215.1 | (89.1) b | 350.5 (31.9) b | 59.5 (5.1) c |
| 5 | 1580 | (73.1) c | 520.1 (34.1) d | 47.5 (5.6) b |
| 10 | 1550 | (88.8) c | 444.1 (43.3) c | 60.7 (4.9) c |
| Proportion of termite nest | | | | |
| powder improvement (%) | | | | |
| 0 | 838.5 | (90.9) a | 205.5 (36.2) a | 18.0 (4.4) a |
| 1 | 1261.5 | (146.8) b | 429.0 (55.1) b | 47.5 (6.8) b |
| 5 | 1218.5 | (136.9) b | 378.2 (48.2) b | 49.2 (7.1) b |
| 10 | 1305.5 | (156.2) b | 364.5 (48.2) b | 53.1 (7.4) b |

| | | | |
|---|---|---|---|
| Proportion of fungal inoculum (PIF) | S | S | S |
| Proportion of termite nest | S | S | S |
| powder improvement (PAT) | | | |
| PIF × PAT | NS | S | S |

S: significant (p < 0.05), NS: not significant (p < 0.05).
⁽¹⁾ Standard Error of the Mean.
⁽²⁾ Data in the same column and for each factor which are followed by the same letter are not significantly different according to the Newman-Keuls test (p < 0.05).
^{(A)} The values are means of 20 samples for the proportions of fungal inoculum and of termite nest powder improvement. The fungal inoculum proportion factor is combined for all treatments with termite nest powder improvement proportions. The termite nest powder improvement factor is combined for all treatments with fungal inoculum proportions.

TABLE 3
Effect of various proportions of endomycorrhizal inoculation and of termite nest
powder improvements on the growth of A. holosericea and on mycorrhizal development
after 2 months' cultivation in 1 litre pots (Second plantation).

| | Aerial biomass | | Root biomass | Mycorrhizal |
|---|---|---|---|---|
| Factor ^{(A)} | (mg dry weight) | | (mg dry weight) | colonization (%) |
| Proportion of | | | | |
| fungal inoculum (%) | | | | |
| 0 | 190.1 | (22.6) ⁽¹⁾ a ⁽²⁾ | 70.5 (8.5) a | 0 a |
| 1 | 783.5 | (41.5) b | 238.1 (18.4) b | 41.8 (2.5) b |
| 5 | 1236.1 | (48.9) c | 357.1 (20.3) c | 70.1 (2.6) d |
| 10 | 1510.1 | (73.9) d | 334.5 (35.9) c | 55.5 (4.3) c |
| Proportion of termite nest | | | | |
| powder improvement (%) | | | | |
| 0 | 709.6 | (101.1) a | 175.0 (25.6) a | 31.0 (5.3) a |
| 1 | 1000.5 | (142.9) b | 274.5 (43.3) b | 47.3 (7.3) b |
| 5 | 1019.5 | (125.2) b | 294.5 (30.7) b | 41.5 (6.4) b |
| 10 | 988.5 | (113.4) b | 256.1 (29.9) ab | 47.5 (6.6) b |

| | | | |
|---|---|---|---|
| Proportion of fungal inoculum (PIF) | S | S | S |
| Proportion of termite nest | S | S | S |
| powder improvement (PAT) | | | |
| PIF × PAT | NS | S | S |

Legend: see Table 2.

As compared with the control the highest biomasses and mycorrhizal colonization indexes were found with the 10% fungal inoculum proportion in the first culture experiment (see Table 2), whereas in the second culture experiment the highest mycorrhizal colonization was recorded with a 5% fungal inoculum rate (see Table 3).

For all combined proportions of termite nest powder improvement in the first culture experiment, growth and mycorrhizal colonization were much higher in soils inoculated with termite nest powder as compared with the control, except for root biomasses for the 10% proportion of termite nest powder improvement (see Table 2).

In the second culture experiment, no important difference was observed between the various inoculation treatments for the root biomasses, but the positive effect of termite nest powder on mycorrhizal colonization was maintained (see Table 3). The highest A. holosericea aerial biomass was recorded in the 5% termite nest powder improvement proportions (see Table 3). Significant interactions between fungal inoculations and termite nest powder improvements were found for root biomasses and mycorrhizal colonization in both culture treatments (see Tables 2 and 3).

Effects of the Improvement in Ectomycorrhizal Fungal Inoculation and in Termite Nest Powder on Plant Growth and Mycorrhizal Colonization for A. holosericea Seedlings.

Ectomycorrhizal inoculation significantly increased the growth and mycorrhizal colonization of A. holosericea seedlings in the two culture experiments (Tables 4 and 5).

TABLE 4
Effect of various proportions of ectomycorrhizal inoculation and of termite nest
powder improvements on the growth of A. holosericea and on mycorrhizal development
after 3 months' cultivation in 1 litre pots (First plantation).

| | Aerial biomass | | Root biomass | Mycorrhizal |
|---|---|---|---|---|
| Factor ^{(A)} | (mg dry weight) | | (mg dry weight) | colonization (%) |
| Proportion of | | | | |
| fungal inoculum (%) | | | | |
| 0 | 278.5 | (26.8) ⁽¹⁾ a ⁽²⁾ | 62.5 (8.9) a | 0 a |
| 1 | 830.5 | (101.9) b | 341.5 (29.4) c | 54.2 (3.2) b |
| 5 | 771.0 | (79.8) b | 261.5 (25.7) b | 54.6 (2.7) b |
| 10 | 813.5 | (104.9) b | 277.5 (31.9) bc | 50.4 (2.4) b |
| Proportion of termite nest | | | | |
| powder improvement (%) | | | | |
| 0 | 658.5 | (122.5) b | 288.5 (42.1) a | 33.5 (4.8) a |
| 1 | 482.5 | (44.9) a | 208.0 (23.6) a | 39.6 (5.4) b |
| 5 | 830.1 | (101.3) c | 268.1 (35.4) a | 42.6 (6.3) b |
| 10 | 722.5 | (93.6) bc | 228.0 (35.3) a | 43.6 (6.3) b |

| | | | |
|---|---|---|---|
| Proportion of fungal inoculum (PIF) | S | S | S |
| Proportion of termite nest | S | NS | S |
| powder improvement (PAT) | | | |
| PIF × PAT | S | S | S |

Legend: see Table 2.

TABLE 5
Effect of various proportions of ectomycorrhizal inoculation and of termite nest
powder improvement on the growth of A. holosericea and on the mycorrhizal development
after 2 months' cultivation in 1 litre pots (Second plantation).

| | Aerial biomass | | Root biomass | Mycorrhizal |
|---|---|---|---|---|
| Factor ^{(A)} | (mg dry weight) | | (mg dry weight) | colonization (%) |
| Proportion of | | | | |
| fungal inoculum (%) | | | | |
| 0 | 191.0 | (27.9) ⁽¹⁾ a ⁽²⁾ | 74.5 (12.9) a | 0 a |
| 1 | 556.5 | (61.4) b | 166.1 (15.2) b | 57.6 (2.1) b |
| 5 | 745.5 | (43.6) c | 221.1 (17.4) c | 61.1 (1.5) c |
| 10 | 1197.5 | (96.6) d | 364.5 (27.1) d | 61.6 (1.9) c |
| Proportion of termite nest | | | | |
| powder improvement (%) | | | | |
| 0 | 501.0 | (77.1) a | 167.0 (27.4) a | 41.1 (5.5) a |
| 1 | 612.2 | (78.1) ab | 195.0 (30.2) ab | 41.6 (5.6) a |
| 5 | 858.6 | (96.9) c | 250.5 (27.8) b | 51.2 (6.8) c |
| 10 | 719.1 | (135.5) bc | 213.5 (33.6) b | 46.3 (6.4) b |

| | | | |
|---|---|---|---|
| Proportion of fungal inoculum (PIF) | S | S | S |
| Proportion of termite nest | S | S | S |
| powder improvement (PAT) | | | |
| PIF × PAT | S | S | S |

Legend: see Table 2.

In the first culture experiment a positive effect of fungal inoculation was found on the growth and mycorrhizal colonization of A. holosericea seedlings (Table 4). Root growth was much more important when plants were inoculated at a rate of 1% (see Table 4). In the second culture treatment, the highest aerial and root biomass was recorded with a 10% proportion of fungal inoculum (Table 5).

Soil improvement with termite nest powder had no significant effect on root growth, whereas this significantly increased mycorrhizal colonization of seedlings in the first culture experiment (see Table 4). As compared with the control (soil without termite nest powder), root growth was significantly lower for the 1% termite nest powder improvement, and higher for the 5% termite nest powder improvement (Table 4).

In the second culture experiment, the positive effects on plant growth and mycorrhizal colonization were only found in 5 and 10% termite nest powder treatments (see Table 5). Significant interactions between fungal inoculations and termite nest powder improvements were found for root biomasses and mycorrhizal colonisation in both culture treatments (see Tables 4 and 5).

Effects of Fungal Inoculation and Termite Nest Powder Improvement on the Mycorrhizal Colonization of A. holosericea Seedlings.

Using the conventional controlled mycorrhiza method and after 4 months' growth, endomycorrhizal and ectomycorrhizal fungal inoculations significantly increased aerial biomass (respectively: +64.7% et+50.9%) and root biomass (respectively: +42.8% and +48.2%) (Table 6). Mycorrhizal colonization rates for A. holosericea seedlings were 59.3% for the endomycorrhizal treatment, and 35.6% for the ectomycorrhizal treatment (see Table 6).

TABLE 6
Effect of ectomycorrhizal and endomycorrhizal inoculations on the growth of
A. holosericea and on mycorrhizal development after 4 months' cultivation
in a greenhouse with the conventional controlled mycorrhiza method.

| | | | |
|---|---|---|---|
| | Aerial biomass | Root biomass | Mycorrhizal |
| Treatments | (mg dry weight) | (mg dry weight) | colonization (%) |

Inoculation Endomycorrhizal

| | | | |
|---|---|---|---|
| Control | 648.1 a ⁽¹⁾ | 312.2 a | 0 |
| Glomus intraradices | 1834.1 b | 546.3 b | 59.3 |

Inoculation Ectomycorrhizal

| | | | |
|---|---|---|---|
| Control | 550 a | 290 a | 0 |
| Pisolithus albus IR100 | 1120.1 b | 560.2 b | 35.6 |

⁽¹⁾ For each type of fungal inoculation, data in the same column which are followed by the same letter are not significantly different according to the Newman Keuls test (p < 0.05).

### Relationship Between the Termite Nest Powder Improvement, Fungal Inoculation and Mycorrhizal Development.

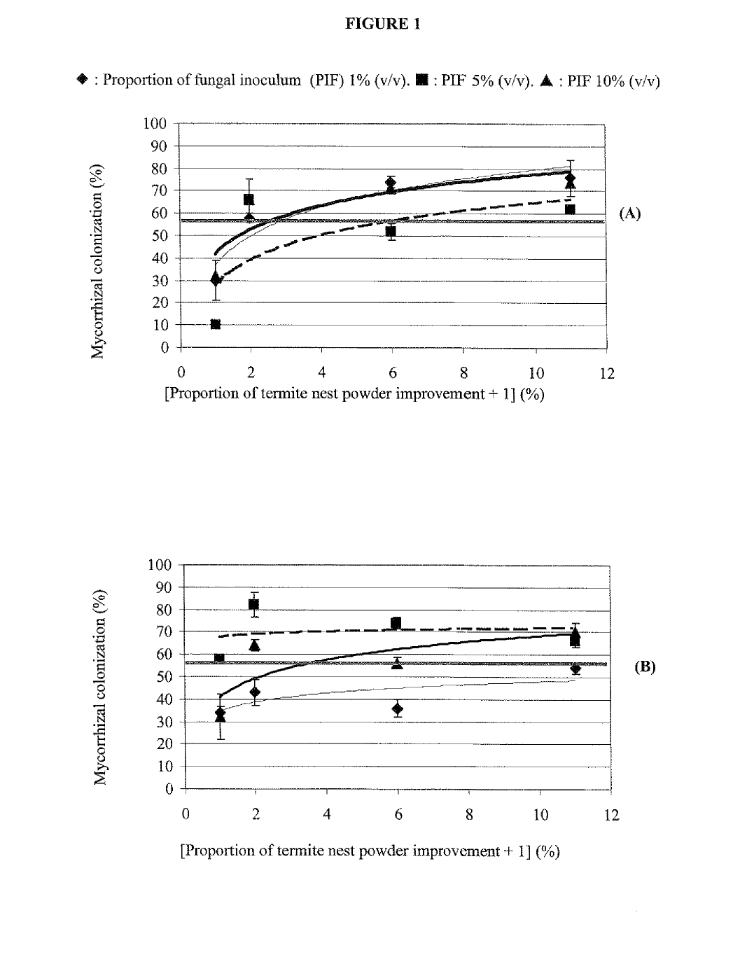

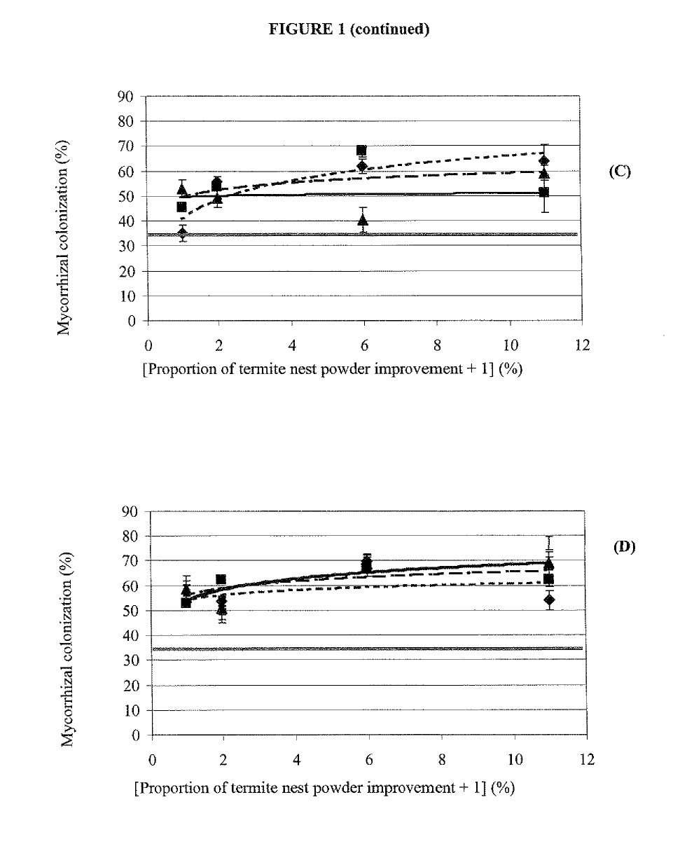

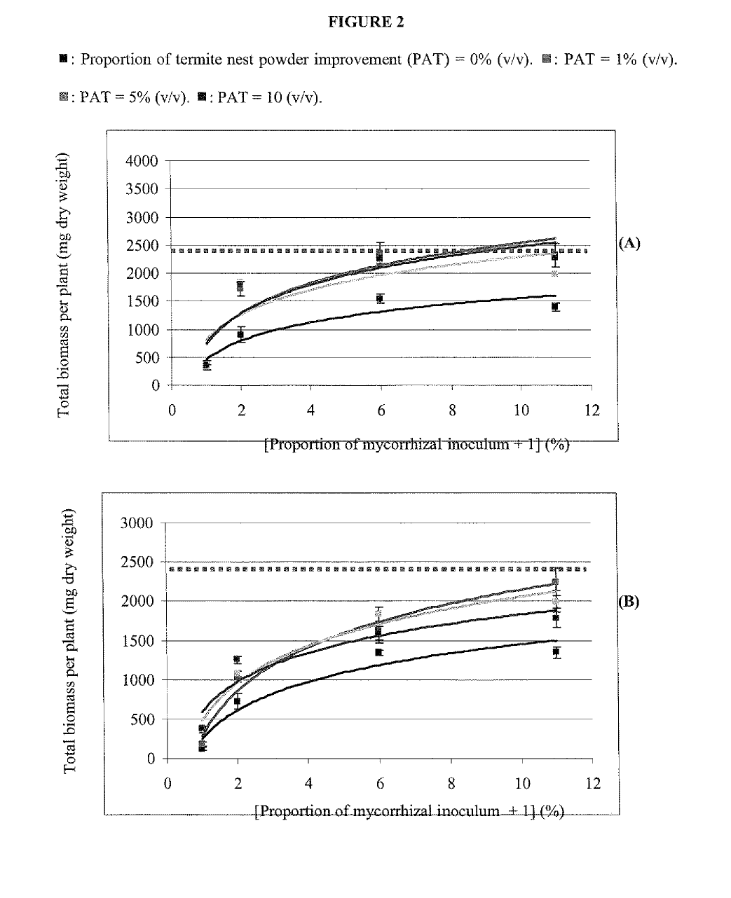

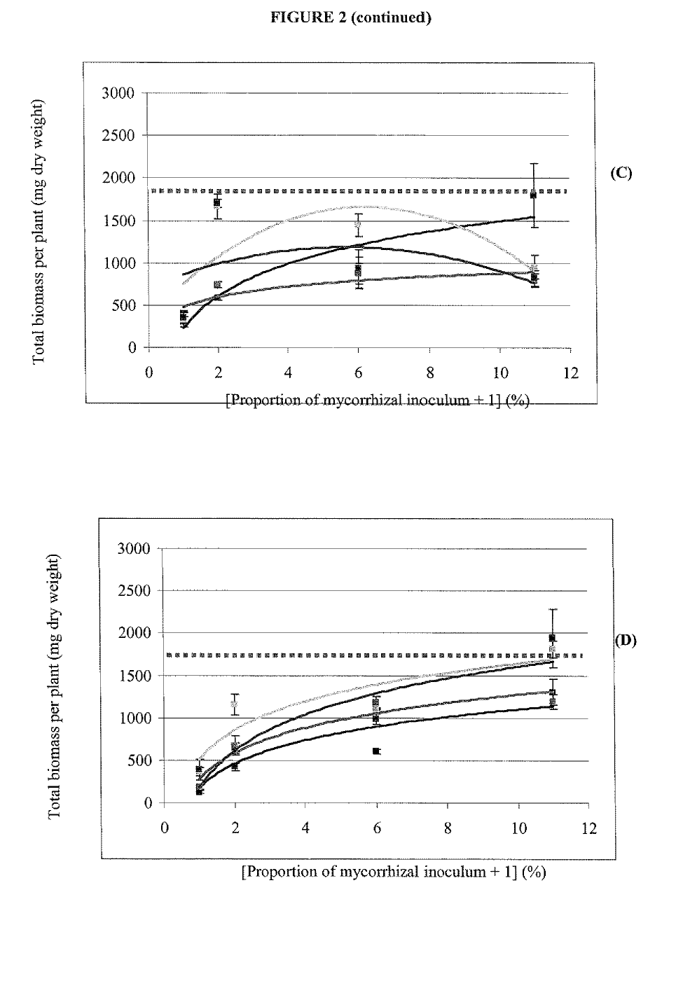

In the two cultivation experiments, endomycorrhizal colonization increased, with increasing rates of termite nest powder improvement, except for the 5% mycorrhizal inoculum in the second cultivation experiment (see FIGS. 1 et 2).

In the first cultivation treatment, endomycorrhizal colonization as obtained with the conventional controlled mycorrhizal method (59.3%) (Table 6) was reached for all mycorrhizal treatment rates when the fungal inoculation was associated with 5% and 10% termite nest powder improvements, and for 1% termite nest powder improvements when associated with a 1 and 10% endomycorrhizal inoculation treatment (FIG. 1A).

In the second cultivation treatment, the 59.3% mycorrhizal colonization was reached for all endomycorrhizal treatments with a 10% termite nest powder improvement, and in treatments with a 5% termite nest powder improvement for an endomycorrhizal inoculation (FIG. 1B). No significant link between mycorrhizal colonization and termite nest powder improvement rates were found in 5% endomycorrhizal inoculation treatments (see FIG. 1B).

For ectomycorrhizal inoculation and in the first cultivation experiment, mycorrhizal indexes were similar or higher than those obtained with the conventional controlled mycorrhiza method (35.6%) (FIG. 1C). Mycorrhizal colonization was positively linked to a growing termite nest powder improvement for a 1% ectomycorrhizal inoculation treatment (see FIG. 1C).

In the second cultivation experiment, the mycorrhizal colonization of A. holosericea seedlings was significantly higher, for all fungal treatments, than that obtained with the conventional method (FIG. 1D). Ectomycorrhization rates were correlated for the proportions of termite nest powder improvements, with the 5% and 10% proportions of ectomycorrhizal inoculum (FIG. 1D).

### Relationship Between the Termite Nest Powder Improvement, Fungal Inoculation and Plant Growth.

For endomycorrhizal inoculation treatments, plant growth was significantly correlated for the amounts of mycorrhizal propagules as inoculated in the soil with or without termite nest powder for both cultivation treatments (FIGS. 2A and B).

When termite nest powders were added, plant growth was significantly increased, and reached that obtained with the conventional mycorrhizal inoculation method (total biomass=2380.3 mg dry weight) for the 10% endomycorrhizal fungal inoculum treatment with the 1%, 5% et 10% termite nest powder improvements in the first cultivation experiment (FIG. 2A) and with 1% and 5% termite nest powder improvements in the second cultivation experiment (FIG. 2B).

For ectomycorrhizal inoculation treatments, plant growth was correlated with the mycorrhizal inoculation rates, except for the 10% fungal treatment as associated with a 10% termite nest powder improvement in the first cultivation treatment (FIGS. 2C et 2D).

The total dry weight of A. holosericea seedlings as conventionally inoculated with P. albus IR100 (total biomass 1680.2 mg dry weight) was reached for the 10% fungal inoculum treatments with 1% and 10% termite nest powder improvements in the second cultivation experiment (FIG. 2D), but was only reached for the 5% fungal inoculum treatment with a 5% termite nest powder improvement in the first cultivation experiment as well as for the soil without P. albus IR100 but amended with 10% termite nest powder (FIG. 2C).

### Example 6

### Conclusion

The principal aims of the experiment were to test the effect of a Macrotermes subhyalinus termite nest powder improvement on the development of mycorrhizae between A. holosericea and an isolate of P. albus (P. albus IR100) and Glomus intraradices by using a cultivation system which is divided into two steps, in order to reduce to a minimum the amounts of fungal inocula as added to the culture substrate. The first step of this cultural practice was carried out in order to inoculate A. holosericea seedlings, whereas the second one allowed the development of these mycorrhized plants in greater volumes of soil.

In this study the termite nest improvement significantly increased the mycorrhizal development of the two fungal isolates. The amounts of termite nest powder which are added to the soil, in the smallest proportion (1%, v/v), induce a significant increase in mycorrhizal development. This positive effect was obtained with only 7.9 10³ CFU per litre culture substrate (ca. 7 bacteriae per gram of soil). This study also shows a significant interaction between fungal doses and termite nest powder improvement rates.

All these results suggest that the use of the termite nest powder, such as M. Subyalinus, which contains a few MHB (<<Mycorrhiza Helper Bacteria>>), yields a beneficial inoculum tool for the development of these bacteriae by protecting bacterial cells from harmful environmental factors.

In most fungal treatments as described in this study, the stimulating effect of the termite nest powder improvement on mycorrhizal development was associated with an increase in plant growth. This suggests that the termite nest powder improvement does not interact with the efficiency of mycorrhizal symbiosis.

One of the problems one comes across in the conventional controlled forest plantation mycorrhiza resides in the large amount of fungal inoculum which is necessary for the production of high quality mycorrhized plants under nursery conditions.

In tropical and Mediterranean areas the dose of mycorrhizal inoculum which is added, per plant, to the cultivation substrate is generally 1 litre per litre soil (ectomycorrhizal inoculation), and 1 gram (fresh weight) of mycorrhizal roots par litre soil (endomycorrhizal inoculation) (Duponnois, R., Plenchetie, C., Prin, Y., Ducousso, M., Kisa, M., Bâ, A. M. & Galiana, A. (2007). Use of mycorrhizal inoculation to improve reafforestation process with Australian Acacia in Sahelian ecozones. Ecological Engineering, 29: 105-112).

With the invention process these amounts are drastically reduced, given that, with only 450 ml ectomycorrhizal or endomycorrhizal inoculum (mixture of spores, mycorrhizal roots and rhizosphere soil), about 100 times more A. holosericea plants may be produced with the same growth and mycorrhizal colonization, than with mycorrhized plants as produced with the conventional mycorrhiza method.

Therefore inoculation costs may be strongly reduced, considering termite nests are commonly found in the ecosystems, and the required fungal amounts are very low.

This inoculation technique may be useful for the reforestation of tropical areas, considering that it is well known that controlled mycorrhization is a beneficial tool to increase the survival and productivity of various tree species in debased areas.

1-35. (canceled)

36) A method for stimulating the mycorrhiza in cultures, notably forest, cereal, fodder, garden, fruit or horticultural crops, comprising the use of at least one fungal inoculum and termite nest powder, said inoculum being used at a dose, for each cultivation unit element, notably grain or plant, which is about ten times less than the dose which is used in the absence of termite nest powder.

37) The method according to claim 36, wherein the termite nest powder is obtained from termites belonging to the genus Macrotermes and preferentially to the genus Macrotermes subhyalinus.

38) The method according to claim 36, wherein the fungal inoculum comprises at least one endomycorrhizal fungus belonging to the genus Glomus, notably which is chosen from among Glomus mosseae, Glomus fasciculatus, Glomus aggregatum, Glomus intraradices and preferentially Glomus intraradices.

39) The method according to claim 36, wherein the fungal inoculum comprises at least an ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum end preferentially Scleroderma dictyosporum,

40) The method according to claim 36, wherein the fungal inoculum comprises an endomycorrhizal fungus belonging to the genus Glomus, notably chosen from among Glomus mosseae, Glomus fasciculatus, Glomus aggregatum, Glomus intraradices and preferentially Glomus intraradices and an ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum et preferentially Scleroderma dictyosporum,

41) The method according to claim 36, wherein the fungal inoculum is prepared by growing an endomycorrhizal fungus on a support, notably in the presence of a mycotrophic plant, notably sandy type, or by growing an ectomycorrhizal fungus on a peat-vermiculite or calcium alginate bead type support.

42) The method according to claim 36, wherein the fungal inoculum and the termite nest powder are associated to a substrate, notably chosen from among sand, compost from cultivation residues and preferentially garden mould, or a mixture of sand and compost.

43) The method according to claim 36, wherein the inoculum:termite nest powder ratio is between 0.1% (v:v)-10% (v:v), preferentially between 0.1% (v:v)-5% (v:v), and more preferentially between 0.1% (v:v)-1% (v:v).

44) The method according to claim 42, wherein the fungal inoculum:substrate ratio of the inoculum is between 1% (v:v)-10% (v:v), preferentially 1% (v:v) 5% (v:v), and is more preferentially 1% (v:v).

45) The method according to claim 42, wherein the termite nest powder:substrate ratio of the inoculum is between 1% (v:v)-10% (v:v), preferentially between 1% (v:v)-5% (v:v) and is more preferentially 1% (v:v).

46) The method according to claim 46, wherein said inoculum is notably an endomycorrhizal fungus, and used in areas to be cultivated, notably for cereal, fodder, garden, fruit or horticultural crops, and preferentially garden, fruit or horticultural crops.

47) The method according to claim 36, wherein said inoculum is notably an ectomycorrhizal fungus, and used in areas to be used for forest tree cultivation.

48) The method according to claim 36, wherein said inoculum is notably an endomycorrhizal and an ectomycorrhizal fungus, and used in areas to be used for forest tree cultivation, notably of ligneous species belonging to the genera Casuarina, Allocasuarina, Eucalyptus and Australian Acacia.

49) A composition of matter comprising:
a) a fungal inoculum comprising at least an endomycorrhizal fungus belonging to the genus Glomus, notably chosen from among Glomus mosseae, Glomus fasciculatus, Glomus aggregatum, Glomus intraradices and preferentially Glomus intraradices,
b) termite nest powder, wherein the particle size of said termite nest powder is between 1 μm-1,000 μm and preferentially between 1 μm-500 μm, the fungal inoculum:termite nest powder ratio being between 0.1% (v:v)-10% (v:v), preferentially between 0.1 (v:v)-5% (v:v), and more preferentially between 0.1 (v:v)-1% (v:v)

50) The composition according to claim 49, wherein the fungal inoculum comprises:
i) at least one endomycorrhizal fungus obtained, for instance, by growing a dose of about 2 g mycorrhized roots of said endomycorrhizal fungus,
ii) a sandy type support,
iii) a mycotrophic plant.

51) The composition according to claim 49, comprising:
a) a fungal inoculum comprising at least an endomycorrhizal fungus,
b) termite nest powder,
c) a substrate chosen from among the compost as obtained from cultivation residues and preferentially from garden mould, sand, or a mixture of sand and compost,
the termite nest powder:substrate ratio being between 1% (v:v)-10% (v:v) and preferentially between 1% (v:v)-5% (v:v), and being more preferentially 1% (v:v), and
the fungal inoculum:substrate ratio being between 1% (v:v)-10% (v:v), preferentially between 1% (v:v)-5% (v:v), and being more preferentially 1% (v:v).

52) A Composition comprising:
a) a fungal inoculum, comprising at least an ectomycorrhizal fungus belonging to the genus Pisolithus, notably chosen from among Pisolithus albus, Pisolithus tinctorius, or to the genus Scleroderma, notably chosen from among Scleroderma dyctiosporum, Scleroderma verrucosum and preferentially Scleroderma dictyosporum,
b) termite nest powder, wherein the particle size of said powder is between 1 μm-1000 μm, preferentially between 1 μm-500 μm,
c) a substrate chosen from among sand, a compost obtained from cultivation residues and preferentially from garden mould, or a mixture of sand and compost,
wherein the fungal inoculum:termite nest powder ratio is between 0.1% (v:v)-10% (v:v), preferentially between 0.1% (v:v)-5% (v:v) and more preferentially between 0.1% (v:v)-1% (v:v), and
the fungal inoculum:substrate ratio being between 1% (v:v)-10% (v:v), preferentially between 1% (v:v)-5% (v:v), and being more preferentially 1% (v:v), and
the termite nest powder:substrate ratio being between 1% (v:v)-10% (v:v), preferentially between 1% (v:v)-5% (v:v), and being more preferentially 1% (v:v),
it being understood that at least one of the two ratios, be it fungal inoculum:substrate or termite nest powder:substrate, is below 10% (v:v), and preferentially that at least one of the two above-mentioned ratios is between 1% (v:v)-5% (v:v).

53) The composition according to claim 52, wherein the fungal inoculum comprises:
i) at least an ectomycorrhizal fungus, obtained for instance by growing a 10 mg (dry weight) biomass dose of ectomycorrhizal fungus.
ii) a peat-vermiculite type (1:4, v:v) or calcium alginate bead support.

54) A composition comprising:
a) a fungal inoculum comprising an endomycorrhizal fungus belonging to the genus Glomus, notably chosen from among Glomus mosseae, Glomus fasciculatus, Glomus aggregatum, Glomus intraradices and preferentially Glomus intraradices, and an ectomycorrhizal fungus belonging to the genus Pisolithus, notably chosen from among Pisolithus albus, Pisolithus tinctorius, or the genus Scleroderma, notably chosen from among Scleroderma dyctiosporum, Scleroderma verrucosum and preferentially Scleroderma dictyosporum,
b) termite nest powder, wherein the particle size of said powder is between 1 μm-1000 μm and preferentially between 1 μm-500 μm,
the fungal inoculum:powder ratio being between 0.1% (v:v)-10% (v:v), preferentially between 0.1% (v:v)-5% (v:v), and more preferentially between 0.1% (v:v)-1% (v:v).

55) The composition according to claim 54, wherein the fungal inoculum comprises:
i) at least one endomycorrhizal fungus obtained for instance by growing a dose of about 2 g mycorrhized roots of said endomycorrhizal fungus and an ectomycorrhizal fungus obtained for instance by growing a 10 mg dose (dry weight) of ectomycorrhizal fungus biomass,
ii) a sandy type support in association with a mycotrophic plant for the endomycorrhizal fungus, and a peat-vermiculite (1:4, v:v) or calcium alginate bead type support for the ectomycorrhizal fungus.

56) The composition according to claim 54, comprising:
a) a fungal inoculum,
b) termite nest powder,
c) a substrate chosen from among a compost obtained from cultivation residues, and preferentially from garden mould, sand, or a mixture of sand and compost,
wherein the termite nest powder:substrate ratio is between 1% (v:v)-10% (v:v), preferentially between 1% (v:v)-5% (v:v), and being more preferentially 1% (v:v), and the fungal inoculum:substrate ratio being between 1% (v:v)-10% (v:v), preferentially between 1% (v:v)-5% (v:v), and being more preferentially 1% (v:v).

57) The composition according to claim 49, wherein the termite nest powder is obtained from termites belonging to the genus Macrotermes, and preferentially to the genus Macrotermes subhyalinus.

58) A process for stimulating mycorrhiza in areas to be cultivated, wherein a mixture of fungal inoculum and termite nest powder, which may be ground, has been introduced, the fungal inoculum having been prepared by growing at least an endomycorrhizal fungus with a support, or by growing at least an ectomycorrhizal fungus on a support, and said inoculum being used at a dose, for each cultivation unit element, notably grain or plant, which is about ten times below the dose which is used in the absence of termite nest powder.

59) The process according to claim 58, wherein the dose of fungal inoculum, for each cultivation unit element, is between 0.01-1 ml, and preferentially between 0.01-0.1 ml.

60) The process according to claim 58, wherein the fungal inoculum is a fungal inoculum which is specific for endomycorrhiza and comprises at least an endomycorrhizal fungus belonging to the genus Glomus, notably chosen from among Glomus mosseae, Glomus fasciculatus, Glomus aggregatum, Glomus intraradices, and preferentially Glomus intraradices

61) The process according to claim 58, wherein the fungal inoculum is a fungal inoculum which is specific for ectomycorrhiza and comprises at least one ectomycorrhizal fungus belonging to the genus Pisolithus, notably chosen from among Pisolithus albus, Pisolithus tinctorius, or belonging to the genus Scleroderma, notably chosen from among Scleroderma dyctiosporum, Scleroderma verrucosum and preferentially Scleroderma dictyosporum.

62) The process according to claim 58, wherein the fungal inoculum is an inoculum which comprises at least one endomycorrhizal fungus belonging to the genus Glomus, notably chosen from among Glomus mosseae, Glomus fasciculatus, Glomus aggregatum, Glomus intraradices and preferentially Glomus intraradices, and at least one ectomycorrhizal fungus belonging to the genus Pisolithus, notably chosen from among Pisolithus albus, Pisolithus tinctorius, or the genus Scleroderma, notably chosen from among Scleroderma dyctiosporum, Scleroderma verrucosum and preferentially Scleroderma dictyosporum.

63) The process according to claim 58, wherein said powder has a particle size between 1 μm-1000 μm and preferentially between 1 μm-500 μm.

64) The process according to claim 58, wherein the termite nest powder is obtained from termites belonging to the genus Macrotermes and preferentially belonging to the genus Macrotermes subhyalinus.

65) The process for stimulating mycorrhiza in areas to be cultivated according to claim 58, wherein a mixture of fungal inoculum and termite nest powder, which may be ground, has been introduced in association with a substrate, the fungal inoculum and the termite nest powder having been mixed with a substrate, and said fungal inoculum having been prepared by growing a mycorrhizal fungus on a support.

66) The process according to claim 58, wherein the inoculum:termite nest powder ratio is between 0.1% (v:v)-10% (v:v), preferentially between 0.1 (v:v)-5% (v:v), and more preferentially between 0.1% (v:v)-1% (v:v).

67) The process according to claim 65, wherein the fungal inoculum is prepared by growing at least one endomycorrhizal fungus at the useful dose of ca. 2 g mycorrhized roots on a support made up of sand in association with a mycotrophic plant, or by growing at least one ectomycorrhizal fungus at the useful dose of about 10 mg (dry weight) of ectomycorrhizal fungus biomass on a support which is made up of peat/vermiculite (1:4, v:v) or calcium alginate beads.

68) The process according to claim 65, wherein the fungal inoculum and the termite nest powder are mixed with a substrate, said substrate being chosen from among sand, compost as obtained from cultivation residues and preferentially garden mould, or a mixture of sand and compost,
the fungal inoculum:substrate ratio being between 1% (v:v)-10% (v:v), preferentially between 1% (v:v)-5% (v:v), and being more preferentially 1% (v:v) and
the termite nest powder:substrate ratio being between 1% (v:v)-10% (v:v), preferentially between 1% (v:v)-5% (v:v), and being more preferentially 1% (v:v).

69) The process according to claim 65, including a step for the introduction of a cultivation unit element into areas to be cultivated, this element containing from the start the fungal inoculum and the termite nest powder, said cultivation unit element notably being a grain or a plant.

70) The process according to claim 65, comprising the following steps:
a) preparation of the fungal inoculum by growing at least an endomycorrhizal fungus and at least an ectomycorrhizal fungus on a support,
b) mixing of the termite nest powder, which may be ground, and of the fungal inoculum with a substrate,
c) introduction of the mixture as obtained at the preceding step into areas to be cultivated, at a dose, per cultivation unit element, between 0.01-1 ml fungal inoculum, and preferentially between 0.01-0.1 ml fungal inoculum,
introduction of a cultivation unit element, notably of a grain or plant to be cultivated, into areas to be used for the cultivation of crops containing the mixture.
